(19) United States
(12) Patent Application Publication
(10) Pub. No.: US 2024/0212455 A1
(43) Pub. Date: Jun. 27, 2024

(54) SLOT MACHINE IMPLEMENTING A SPEED SPIN DISCOUNT

(71) Applicant: IGT, Las Vegas, NV (US)

(72) Inventor: Nathan Ajhar, Sparks, NV (US)

(21) Appl. No.: 18/087,583

(22) Filed: Dec. 22, 2022

(51) Int. Cl. G07F 17/32

(52) U.S. Cl. CPC G07F 17/3269; G07F 17/3258; G07F 17/3288

(57) ABSTRACT

The present disclosure relates generally to computational devices and, in particular, toward a computational device, system, and method of operating a computational device. The method may include determining that a spin discount is available when a speed spin feature is activated and then applying the spin discount on a next reel spin.

### BACKGROUND

The present disclosure is directed toward a slot machine and, in particular, a slot machine that implements a speed spin discount.

Operators continually improve the functionality and game play features of gaming machines to enhance overall player/user experience. Any type of game play feature that presents the player/user with an additional opportunity to win and/or discount is often viewed as desirable and can lead to increased play of the gaming machine.

### BRIEF SUMMARY

In certain embodiments, the present disclosure relates to a method of operating a computational device, including: initiating a timer and a spin counter after a first reel spin of a reel, wherein the timer is associated with a spin discount; after one or more reel spins occurring subsequent to the first reel spin, while the timer is still active and until a maximum number of reel spins is reached, incrementing the timer and the spin counter; after the maximum number of reel spins is reached, and if the timer is still active, then determining, with a processor of the computational device, the spin discount to be applied to a next reel spin, wherein the spin discount depends, at least in part, on a current value of the timer; and applying the determined spin discount to the next reel spin.

In some embodiments, the present disclosure also relates to a computational device including: a user interface and a processor coupled with the user interface. The computational device is further disclosed to include a computer-readable storage medium, coupled with the processor, comprising instructions that are executable by the processor, wherein the instructions comprise: instructions that: initiate a timer and a spin counter after a first reel spin of a reel; determine if the timer is still active and if a maximum number of reel spins has been reached; after one or more reel spins occurring subsequent to the first reel spin, if the timer is still active, and if the maximum number of spins has not been reached, then increment the timer and the spin counter; when the maximum number of reel spins is reached, if the timer is still active, then determine a spin discount to apply to a next reel spin; and apply the determined spin discount to the next reel spin.

In some embodiments, the present disclosure also relates to a system that includes: a processor; and a computer-readable storage medium, coupled with the processor, comprising instructions that are executable by the processor, wherein the instructions comprise: instructions that initiate a first reel spin of a reel; initiate a timer and a spin counter after the first reel spin of a reel; initiate one or more reel spins subsequent to the first reel spin; in response to the one or more subsequent reel spins, determine if the timer is still active and if a maximum number of reel spins has been reached; if the timer is still active and if the maximum number of spins has not been reached then increment the timer and the spin counter; when the maximum number of reel spins is reached, if the timer is still active, then determine a spin discount to be applied to a next reel spin; and apply the determined spin discount to the next reel spin.

Additional features and advantages are described herein and will be apparent from the following Description and the figures.

### BRIEF DESCRIPTION OF THE SEVERAL VIEWS OF THE DRAWINGS

FIG. 1A depicts one example of a computational device in accordance with embodiments of the present disclosure;

FIG. 1B depicts another example of a computational device in accordance with embodiments of the present disclosure;

FIG. 2 is a block diagram depicting components of a computational device in accordance with embodiments of the present disclosure;

FIG. 3 is an illustrative layout of symbols within an array of symbol areas in accordance with embodiments of the present disclosure;

FIG. 4 is a flow chart illustrating a game play method with a speed spin discount in accordance with embodiments of the present disclosure.

### DETAILED DESCRIPTION

Embodiments of the present disclosure will be described in connection with a computational device and, in particular, a computational device, such as a slot machine or Electronic Gaming Machine (EGM), that implements speed spin discount. While embodiments of the present disclosure will be described in connection with the example of a slot machine or EGM implementing a discount for speed spinning (e.g., multiple spins within a certain amount of time), it should be appreciated that embodiments of the present disclosure are not so limited. For instance, other types of computational devices, such as portable user devices, smartphones, tablets, laptops, Personal Computers (PCs), wearable devices, etc. may be used to implement a discount for speed spinning as part of a game as described herein. Furthermore, it should be appreciated that embodiments of the present disclosure may apply to games other than slot games. For instance, embodiments of the present disclosure may be used in connection with any type of game, such as bingo, keno, slots, video poker, table games, etc.

In some embodiments, a player is presented with an offered discount for making a certain number of spins within a certain time frame. For example, the player may be offered a discount on a subsequent wager if five spins are completed within a certain amount of time. The discount may be a percentage of the current bet level/wager. Alternatively, or additionally, the discount may be based on the number of spins completed in the timeframe. Each subsequent spin, until a maximum number of spins is reached, may keep the timer active. For example, a countdown timer may reset after each spin, until the maximum number of spins is reached. In another example, additional time (e.g., one second) may be added to a timer after each subsequent spin until a maximum number of spins is reached. Once the maximum number of subsequent spins (e.g., four spins after a first spin) is reached, if the timer is still active, the player may be offered a discount on the next reel spin.

In some embodiments, the timer and/or spin counter are displayed along with the game. Additionally, an amount of the discount may be displayed. In some embodiments, the discount may accumulate as the player plays, until a maximum discount is reached. In embodiments, the discount is based, at least partly, on a player's bet during the original spin (e.g., “first reel spin”).

Embodiments of the present disclosure also contemplate a game play scenario in which a player/user is awarded a discount based on spins completed in a given timeframe. The discount may be accumulated after each spin or may be awarded after the maximum number of spins is completed before a timer runs out. For example, during game play, a timer is activated, a spin discount feature allows the player to accumulate a spin discount while the timer is active, the faster the players spins, the more the spin discount may stack up until a maximum discount amount and/or expiration of the timer.

As mentioned above, this speed spin discount may be made available within the context of a slot game, or any other game of chance that awards particular symbol combinations relative to positions on a user interface.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

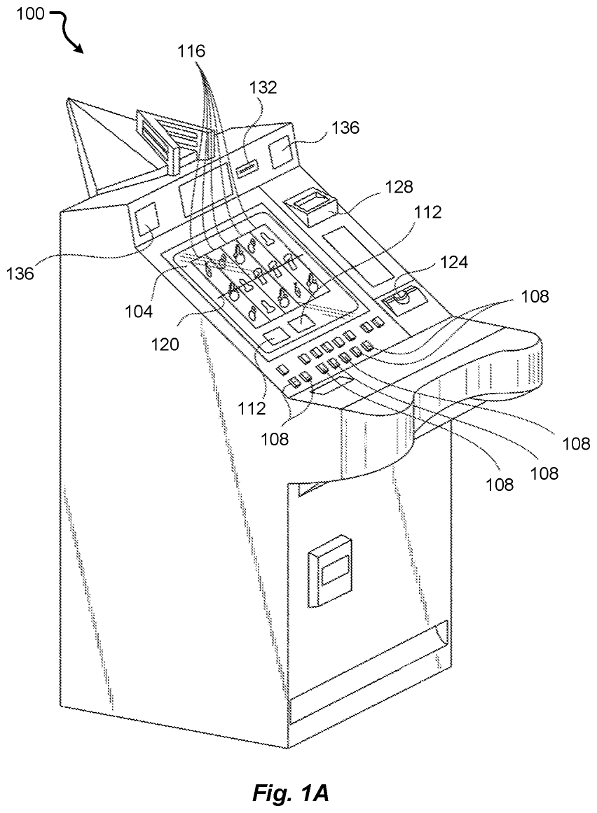

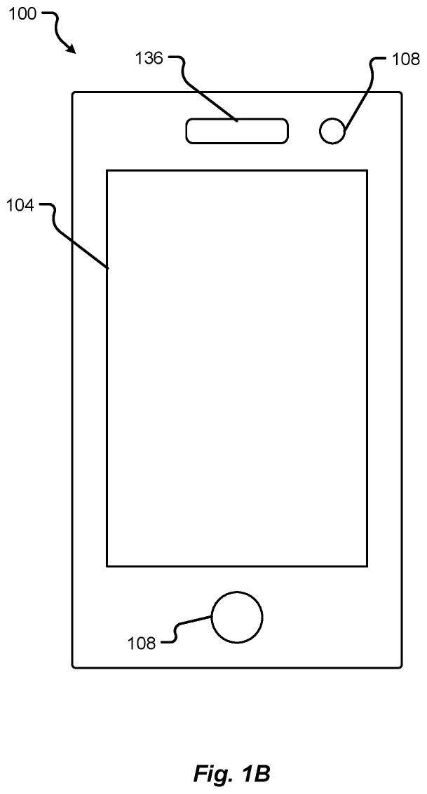

With reference now to FIGS. 1A and 1B, an illustrative computational device 100 that may be used to implement a slot game or the like will be described in accordance with at least some embodiments of the present disclosure. A computational device 100 may include a portable or non-portable device used for executing a gaming application or multiple different gaming applications without departing from the scope of the present disclosure. Non-limiting examples of a computational device include an EGM, a Video Gaming Machine (VGM), a mobile communication device (e.g., a smartphone, laptop, wearable device, etc.), a laptop, a PC, etc. An EGM or VGM-type of computational device 100 is shown in FIG. 1A in accordance with embodiments of the present disclosure.

The illustrative computational device 100 of FIG. 1A is shown to include a support structure, housing or cabinet, which provides support for a plurality of displays, inputs, controls and other features of a conventional gaming machine. In the illustrated embodiment, a player plays computational device 100 while sitting; however, the computational device 100 is alternatively configured so that a player can operate it while standing or sitting. The illustrated computational device 100 is positioned on the floor but can be positioned alternatively (i) on a base or stand, (ii) as a pub-style table-top game (e.g., where the participant computational devices are located remotely from the shared wheel as discussed below), (iii) as a stand-alone computational device on the floor of a casino with other stand-alone computational devices, or (iv) in any other suitable manner. The computational device 100 can be constructed with varying cabinet and display configurations.

In one embodiment, a computational device 100 is configured to randomly generate awards and/or other game outcomes based on probability data. Since a computational device 100 generates outcomes randomly or based upon a probability calculation, there is no certainty that the computational device 100 will provide the player with any specific award or other game outcome.

In some embodiments, a computational device 100 may employ a predetermined or finite set or pool of awards, progressive awards, prizes or other game outcomes. As each award or other game outcome is provided to the player, the computational device 100 removes the provided award or other game outcome from the predetermined set or pool. Once removed from the set or pool, the specific provided award or other game outcome cannot be provided to the player again. The computational device 100 provides players with all of the available awards or other game outcomes over the course of the play cycle and guarantees a designated amount of actual wins and losses.

The computational device 100 may include one or more displays 112. An illustrative display 112 may include a credit display that displays a player's current number of credits, cash, account balance or the equivalent. Another illustrative display 112 may include a bet display that displays a player's amount wagered.

The computational device 100 is also shown to include at least one payment acceptor. Illustrative payment acceptors may include, without limitation, a coin slot 124, where the player inserts coins or tokens, and a ticket, note or bill acceptor 128, where the player inserts a bar-coded ticket, note, or cash. In one embodiment, a player-tracking card, credit card, debit card or data card reader/validator 132 is also provided for accepting any of those or other types of cards as a form of payment toward playing a game on the computational device 100.

In one embodiment, a player inserts an identification card into card reader 132 of computational device 100. The identification card can be a smart card having a programmed microchip or a magnetic strip coded with a player's identification, credit totals and other relevant information. In one embodiment, money may be transferred to computational device 100 through an electronic fund transfer and card reader 132 using the player's credit, debit or smart card. When a player funds computational device 100, a processor of the computational device 100 may determine the amount of funds entered and the corresponding amount is shown on the credit or other suitable display 112 as described above.

In one embodiment, after appropriate funding of computational device 100, the player presses an input device 108 to initiate game play. Input devices 108 may include various types of buttons, levers, gesture inputs, etc. that enable a player to start any game play or sequence of events. In one embodiment, upon appropriate funding, computational device 100 begins game play automatically. In another embodiment, the player needs to actuate or activate one of the play buttons to initiate play of computational device 100. Other non-limiting types of input devices 108 may include a bet one button, a max bet button, or any other type of button known to be included in an EGM, VGM, or the like. It should further be appreciated that the input devices 108 may correspond to a physical button, a virtual button on a touch-screen of a game, an input element on a Graphical User Interface (GUI), or a combination thereof. In other words, the input devices 108 do not need to correspond to a physical button.

In some embodiments, the player places a bet by pushing a bet one button. The player may increase the player's wager by one credit each time the player pushes the bet one button. When the player pushes the bet one button, the number of credits shown in the credit display decreases by one, and the number of credits shown in the bet display increases by one. A max bet button can also be provided, which enables the player to bet the maximum wager (e.g., max lines, max wager per line, and re-spin operation). Computational device 100 may include other suitable wager buttons, such as a repeat bet button, one or more select pay lines buttons, a select re-spin operation button, and one or more select wager per pay line buttons.

Another type of input device 108 that may be provided on the computational device 100 is a physical cash out button, a virtual cash out button, a selectable GUI element, or the like. The player presses a cash out button and cashes out to receive a cash payment or other suitable form of payment corresponding to the number of remaining credits. The player can receive coins or tokens in a coin payout tray or a ticket or credit slip, which are redeemable by a cashier or funded to the player's electronically-recordable identification card.

The computational device 100 may also include one or more display screens 104 and one or more sound-generating devices 136 (e.g., speaker(s)). The combination of outputs provided on a display screen 104 and sound-generating device 136 may contribute to the game play experience and, in some embodiments, may provide the player with information regarding a status of a game play event or sequence of events.

In one embodiment, the sound-generating device 136 may include at least one speaker or other type of transducer for generating audible sounds, playing music, etc. In one embodiment, a computational device 100 provides dynamic sounds coupled with attractive multimedia images displayed on display screen 104 to provide an audio-visual representation or to otherwise display full-motion video with sound to attract players to computational device 100. During idle periods, the computational device 100 displays a sequence of audio and/or visual attraction messages to attract potential players to computational device 100.

In one embodiment, a base or primary game includes a slot game with one or more pay lines 120. As will be discussed in further detail herein, the game provided by the computational device 100 may support one or multiple pay lines 120, which may extend across the display screen 104 vertically, horizontally, diagonally, at adjusted angles, etc. In some embodiments, such as for a slot game, a pay line 120 intersects a plurality of reels 116, such as three to five reels. Each reel 116 of the display screen 104 may be used to display different sets of symbols in connection with game play activity provided by the computational device 100. In some embodiments, each reel 116 may operate independent of all other reels and the symbols displayed by a reel 116 at the end of a given spin may depend upon random numbers generated by the computational device 100.

The reels 116 may be provided as mechanical rotating reels, electromechanical rotating reels, and/or in video form with simulated reels being displayed via the display screen 104. A reel 116 may be used to display any number of symbols such as bells, hearts, fruits, numbers, letters, bars or other images, which preferably correspond to a theme associated with a game provided by the computational device 100. With a slot game, computational device 100 may be configured to award prizes, awards, or other game play opportunities when the reels 116 stop spinning and a predetermined symbol combination lands across an active pay line 120 (e.g., a pay line 120 that is currently being wagered and is subject to evaluation for a win after the reels 116 have stopped spinning).

FIG. 1B illustrates another example of a computational device 100 in accordance with at least some embodiments of the present disclosure. This particular example of computational device 100 may correspond to a portable computational device 100 such as a mobile smartphone, tablet, wearable, etc. The computational device 100 may be owned by a user of the device 100 rather than being owned by a casino operator.

The computational device 100 again includes a display screen 104, a plurality of input devices 108, and at least one speaker 136. In some embodiments, the display screen 104 may correspond to a touch-sensitive display screen, meaning that the display screen 104 is simultaneously capable of displaying information (e.g., in connection with game play activity) and receiving a user input. In some embodiments, the touch-sensitive display screen 104 may provide game features similar to a cabinet-style computational device 100 without requiring all of the dedicated buttons provided by a cabinet-style computational device 100.

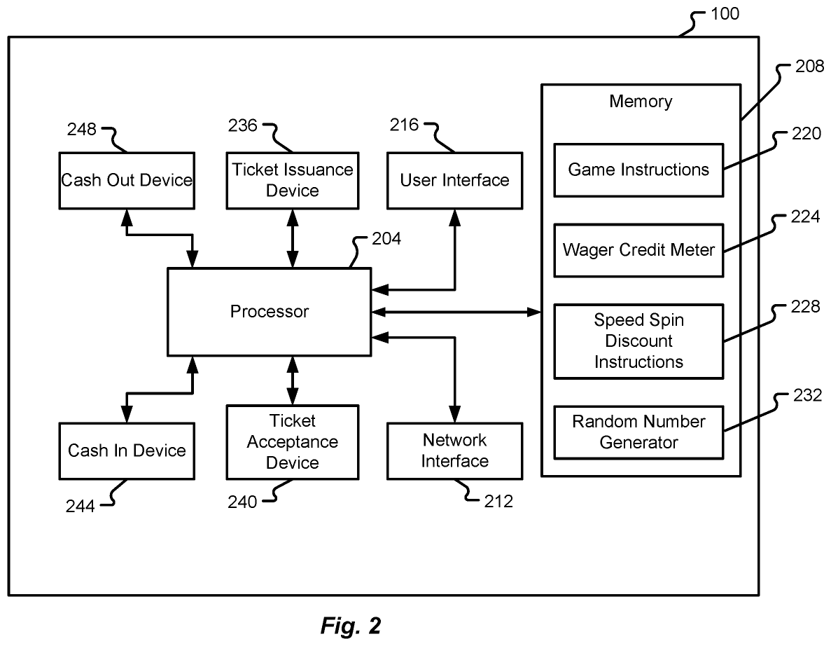

With reference now to FIG. 2, additional details of the components that may be included in a computational device 100 will be described in accordance with at least some embodiments of the present disclosure. The computational device 100 is shown to include a processor 204, memory 208, a network interface 212, and a user interface 216. In some embodiments, the processor 204 may correspond to one or many microprocessors, CPUs, microcontrollers,

Integrated Circuit (IC) chips, or the like. The processor 204 may be configured to execute one or more instruction sets stored in memory 208. In some embodiments, the instruction sets stored in memory 208, when executed by the processor 204, may enable the computational device 100 to provide game play functionality.

The nature of the network interface 212 may depend upon whether the network interface 212 is provided in cabinet-style computational device 100 or a mobile computational device 100. Examples of a suitable network interface 212 include, without limitation, an Ethernet port, a USB port, an RS-232 port, an RS-485 port, a NIC, an antenna, a driver circuit, a modulator/demodulator, etc. The network interface 212 may include one or multiple different network interfaces depending upon whether the computational device 100 is connecting to a single communication network or multiple different types of communication networks. For instance, the computational device 100 may be provided with both a wired network interface 212 and a wireless network interface 212 without departing from the scope of the present disclosure.

The user interface 216 may include a combination of the user input and user outputs described in connection with FIGS. 1A and 1B. For instance, the user interface 216 may include the display screen 104, the input devices 108, the speakers 136, or any other component that is capable of enabling user interaction with the computational device 100. The user interface 216 may also include one or more drivers for the various hardware components that enable user interaction with the computational device 100.

The memory 208 may include one or multiple computer memory devices that are volatile or non-volatile. The memory 208 may be configured to store instruction sets that enable player interaction with the computational device 100 and that enable game play at the computational device 100. Examples of instruction sets that may be stored in the memory 208 include a game instruction set 220, a credit meter 224, and a speed spin discount instruction set 228. In addition to the instruction sets, the memory 208 may also be configured to store a random number generator 232 that is used by the game instruction set 220, for example, to provide game outputs.

In some embodiments, the game instruction set 220, when executed by the processor 204, may enable the computational device 100 to facilitate one or more games of chance or skill and produce interactions between the player and the game of chance or skill. In some embodiments, the game instruction set 220 may include subroutines that present one or more graphics to the player via the user interface 216, subroutines that calculate whether a particular wager has resulted in a win or loss during the game of chance or skill, subroutines for determining payouts for the player in the event of a win, subroutines for exchanging communications with another device, such as a server, subroutines for determining re-spin opportunities during game play, and any other subroutine useful in connection with facilitating game play at the computational device 100.

In some embodiments, the game instruction set 220 may include instructions that initiate a reel spin at the various reels 116 in connection with game play. In some embodiments, the random number generator 232 is used to determine a final position of the reels 116 after the spin is completed. The game instruction set 220 may also be configured to present symbols via the display screen 104 when the reels 116 correspond to video reels or the like. The game instruction set 220 may also be configured to evaluate a position of symbols relative to one or more pay lines 120, relative to predetermined symbol areas, and any other evaluation desired to facilitate game play.

The credit meter 224 may correspond to an instruction set within the computational device 100 that facilitates a tracking of wager activity at the computational device 100. In some embodiments, the credit meter 224 may be used to store or log information related to various player activities and events that occur at the computational device 100. The types of information that may be maintained in the credit meter 224 include, without limitation, player information, available credit information, wager amount information, and other types of information that may or may not need to be recorded for purposes of accounting for wagers placed at the computational device 100 and payouts made for a player during a game of chance or skill played at the computational device 100.

In some embodiments, the credit meter 224 may be configured to track coin in activity, coin out activity, coin drop activity, jackpot paid activity, credits applied activity, external bonus payout activity, voucher in activity, voucher out activity, spin discounts, timing of events that occur at the computational device 100, and the like. In some embodiments, certain portions of the credit meter 224 may be updated in response to outcomes of a game of chance or skill played at the computational device 100.

The speed spin discount instruction set 228 may correspond to a subroutine that is called by the game instruction set 220 during game play. In some embodiments, the speed spin discount instruction set 228 may be called by the game instruction set 220 when the game instruction set determines that a speed spin discount is available and/or that a speed spin discount lock feature is allowable during the gameplay operation.

In some embodiments, the speed spin discount instruction set 228 is configured, when executed by the processor 204, to initiate a timer and a spin counter after a first reel spin of a reel. The timer and spin counter may be used to determine whether a speed spin discount is to be awarded to the player. After one or more reel spins occurring subsequent to the first reel spin, if the timer is still active and until a maximum number of reel spins has been reached, the speed spin discount instruction set 228 increments the timer and the spin counter. Once the maximum number of reel spins is reached, if the timer is still active, the speed spin discount instruction set 228 determines a spin discount to be applied to a next reel spin. In embodiments, the spin discount depends, at least in part, on a current value of the timer. The speed spin discount instruction set 228 further applies the determined spin discount to the next reel spin.

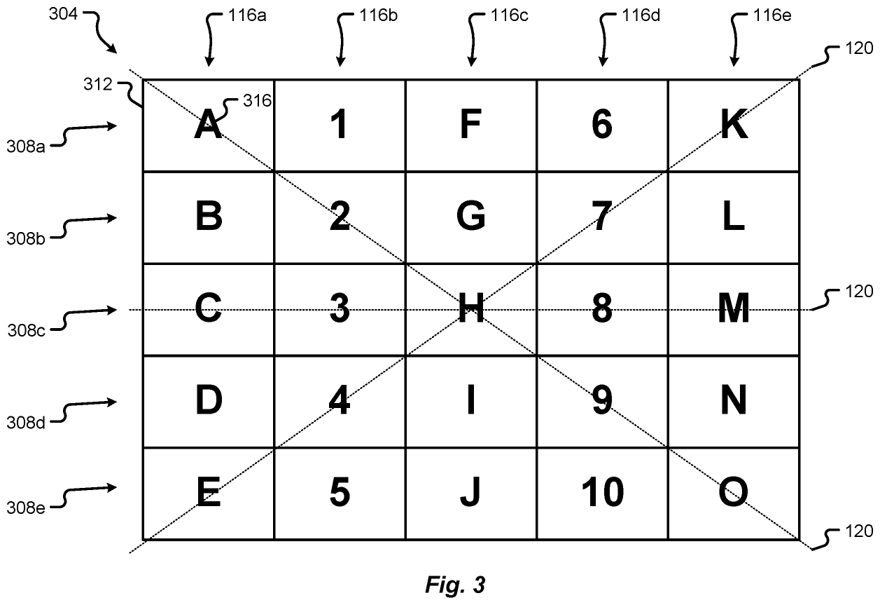

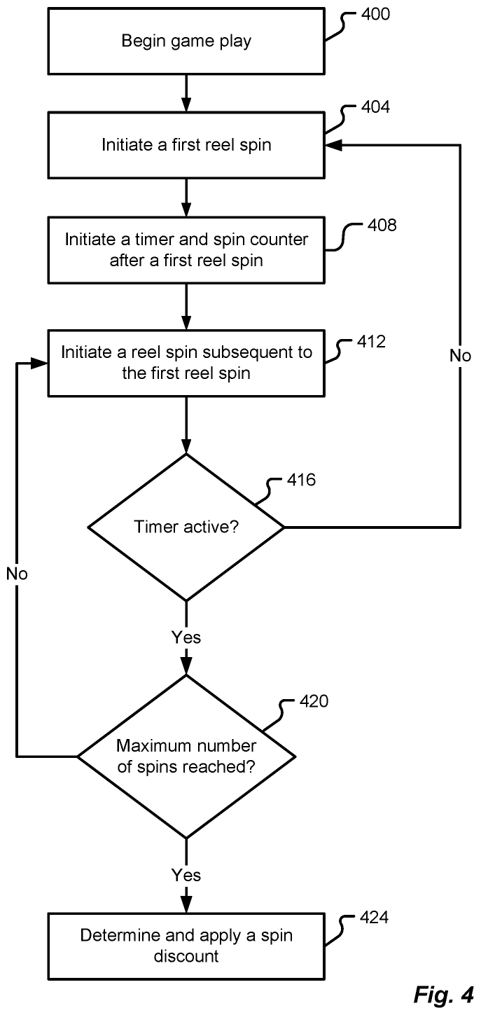

While shown as separate instruction sets, it should be appreciated that the speed spin discount instruction set 228 may correspond to a subroutine of the game instruction set 220 without departing from the scope of the present disclosure. Additional details and functional capabilities of the speed spin discount instruction set 228 working in cooperation with the game instruction set 220 will be described in connection with FIGS. 3-4.

The computational device 100 is further shown to include a ticket issuance device 236, a ticket acceptance device 240, a cash in device 244, and a cash out device 248. The ticket issuance device 236 may be configured to receive physical tickets, vouchers, or player loyalty cards. In some embodiments, the ticket issuance device 236 and ticket acceptance device 240 may operate in concert with the ticket acceptor 128. In such an embodiment, the ticket acceptor 128 may correspond to the physical components that receive and issue a ticket or voucher whereas the ticket acceptance device 240 and ticket issuance device 236 correspond to the drivers and/or firmware components that control operation of the ticket acceptor 128. It should also be appreciated that the card reader 132 may be in communication with the ticket issuance device 236 and ticket acceptance device 240 and may have functionality driven by one or both of these devices. For instance, the card reader 132 may correspond to the physical hardware components that receive information from a player loyalty card (or player loyalty application on a mobile communication device) and that information may be processed by the ticket acceptance device 240 when receiving player credits from cards read by the card reader 132. The ticket issuance device 236 may provide the card reader 132 with information for applying wager credits back to a player card when a player is done with a game play session and wishes to transfer credits from the credit meter 224 back onto their card. Thus, the ticket issuance device 236 and ticket acceptance device 240 may also operate as a driver and/or firmware component for the card reader 132.

Similarly, the cash in device 244 and cash out device 248 may include or operate in concert with the coin slot 124 and any coin delivery mechanisms. The cash in device 244 and cash out device 248 may include hardware, drivers, or firmware that facilitate receiving or distributing cash, tokens, bills, etc. In some embodiments, the cash in device 244 may be configured to determine an amount of cash (e.g., in coins, bills, etc.), an amount of tokens, etc., input at the coin slot 124 and convert the values into credits for playing games with the game instruction set 220. The cash out device 248 may correspond to hardware and software configured to output coins, tokens, bills, etc. if a player decides to cash out or convert playing credits back into cash, tokens, bills, etc.

Referring initially to FIG. 3, a first layout of an array of symbol areas 304 will be described in accordance with embodiments of the present disclosure. The array of symbol areas 304 may be presented with the display screen 104. In some embodiments, the game instruction set 220 may control which particular symbols 316 are presented within a particular symbol area 312. The illustrative array of symbol areas 304 is shown to include five columns 116a, 116b, 116c, 116d, 116e of symbol areas 312 and five rows 308a, 308b, 308c, 308d, 308e of symbol areas 312. Although FIG. 3 illustrates a 5×5 array of symbol areas 304, it should be appreciated that embodiments of the present disclosure can be implemented in an array of symbol areas 304 having a variety of sizes. For instance, embodiments of the present disclosure may be used in an array of symbol areas 304 that are 3×3, 3×5, 5×3, 7×3, 10×5, 10×10, etc. The example layout of the array of symbol areas 304 should not be construed as limiting embodiments of the present disclosure.

As can be seen in FIG. 3, each symbol area 312 in the array of symbol areas 304 may be populated with a single symbol 316. In other words, after the game instruction set 220 has applied a random number generator 232 to determine symbol 316 placement throughout the array of symbol areas 304, there will be a 1:1 correlation of symbols 316 to symbol areas 312. Each column 116a, 116b, 116c, 116d, 116e may also be referred to as a reel 116, particularly in the event that the game instruction set 220 provides a slot game. If a slot game is implemented, then the reels 116 (mechanical or video) are spun (physically or virtually) and their final position after the spin is determined, at least in part, with assistance of the random number generator 232.

In some embodiments, payouts or other predetermined game outcomes (e.g., bonus spin opportunities, prize wins, cash wins, re-spin bonus play, etc.) may be determined based on a symbol combination that falls on a pay line 120 that was subject to a wager prior to the spin. In some embodiments, a plurality of the pay lines 120 may be selected for “play” prior to a spin, meaning that any pay line 120 selected for “play” will be evaluated for a predetermined symbol combination.

With reference now to FIG. 4, a game play method with a possibility of a speed spin discount will be described in accordance with at least some embodiments of the present disclosure. The method begins when game play is initiated by a player of the computational device 100 (step 400). This step may occur in response to the player selecting a predetermined input device 108, e.g., a button, inserting coins, cash, tickets, vouchers, etc., or performing some other action at the computational device 100 that indicates a desire to begin game play.

The method may continue by the game instruction set 220 initiating a first reel spin that leverages the random number generator 232 to determine a final position of symbols (step 404). After the first reel spin is initiated/completed, the game instruction set 220 may initiate a timer (e.g., a countdown timer) and a spin counter (step 408). Once the timer and/or spin counter is initiated, one or more subsequent reel spins is initiated (step 412).

For each subsequent reel spin occurring after the first reel spin, the game instruction set 220 determines if the timer is still active (step 416). If the timer is not active (No) (e.g., a countdown timer has expired), then the game instruction set 220 returns to step 404. If the timer is active (Yes), the game instruction set 220 determines if the maximum number of spins has been reached (step 420). If the maximum number of spins has not been reached (No), then the game instruction set 220 proceeds back to step 412 and determines if another subsequent reel spin has occurred. The timer may be reset, or additional time may be added to the timer, additionally the spin counter is incremented. Steps 412 and 416 are repeated until the timer is not active or until the maximum number of spins is reached.

If the maximum number of spins has been reached (Yes), the game instruction set 220 determines/applies the spin discount (step 424). In embodiments, the spin discount to be applied may be based, at least in part, on a value of the timer. For example, a percentage discount (e.g., 5-10% discount on next reel spin) may be based on the time remaining (e.g., 1-2 seconds remaining=5% discount; 3-5 seconds remaining-7% discount; >5 seconds remaining=10% discount). In another example, as long as the timer is active (e.g., time remaining on the timer), a discount is applied; in other words, the discount is the same regardless of the value of the timer. In embodiments, the discount may be based on how fast the player spins/bets. For example, the timer comprises a count up timer (timer expires when a maximum time is reached), and the discount is based on how fast (e.g., value of count up timer) when the maximum number of spins is reached (e.g., 10 seconds to reach maximum number of spins=5% discount, 5 seconds to reach maximum number of spins=6% discount, 3 seconds to reach maximum number of spins=10% discount). In other words, the faster the player spins the higher the discount. The discount amount may have a linear, exponential, or other relationship to the timer value. The discount may be further based on other factors, including but not limited to bet amount, game play time, player status, in game special features, time of day, etc.

The game instruction set 220 will cause the computational device 100 to perform an action consistent with the determined spin discount. The game instruction set 220 may display a prompt indicating the amount of the spin discount to be applied, and/or may query the player about applying the spin discount. If the player does not apply the spin discount, the spin discount may be accumulated to unlock other rewards, game play features, etc. In embodiments, the spin discount feature may be activated via user input to a display prompt. In embodiments, the spin discount feature may be offered based on game play, player status, time of day, time of year, etc.

Eventually, the game instruction set 220 will evaluate the timer and spin counter to determine if the first spin resulted in a predetermined game outcome. The predetermined game outcome may include receiving a spin discount on the next spin, winning a prize, winning playing credit, winning money, winning a bonus spin, achieving a game achievement, etc. Steps 404, 408, 412, 416, 420, and 424 may repeat until game play has ended (e.g., player cashes out). In embodiments, the spin discount is offered for a predetermined amount of time (e.g., one hour; 10 am-2 pm; etc.), and ends after the predetermined time even if the player continues with game play. Additionally, or alternatively, the spin discount is offered for a predetermined number of spins (e.g., discount ends after a predetermined number of spin discounts is awarded) even if the player continues with game play. In embodiments, the spin discount may be stacked, for example, after a predetermined number of spin discounts is applied, a next level (e.g., higher) spin discount may be applied. A second timer may be activated, and the next level of the spin discount will remain active while the second timer is active until a maximum spin discount is reached. In embodiments, the spin discount may be combined with other game features. For example, instead of, or in addition to, applying a spin discount based on the method described herein, other game features may be unlocked based on speed spinning (e.g., a predetermined number of spin within a predetermined amount of time).

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C #, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (Saas).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The invention is claimed as follows:

1. A method of operating a computational device, the method comprising:
initiating a timer and a spin counter after a first reel spin of a reel, wherein the timer is associated with a spin discount;
after one or more reel spins occurring subsequent to the first reel spin, while the timer is still active and until a maximum number of reel spins is reached, incrementing the timer and the spin counter;
after the maximum number of reel spins is reached, and if the timer is still active, then determining, with a processor of the computational device, the spin discount to be applied to a next reel spin, wherein the spin discount depends, at least in part, on a current value of the timer; and
applying the determined spin discount to the next reel spin.

2. The method of claim 1, further comprising:
providing a prompt, with a user output device of the computational device, to indicate a remaining time on the timer.

3. The method of claim 1, further comprising:
providing a prompt, with a user output device of the computational device, to indicate an amount of the spin discount.

4. The method of claim 1, wherein the timer is a countdown timer.

5. The method of claim 4, wherein incrementing to the timer comprises resetting the timer.

6. The method of claim 4, wherein incrementing the timer comprises adding additional time to the timer.

7. The method of claim 1, wherein the spin discount further depends, at least in part, on a bet level.

8. The method of claim 1, wherein the spin discount further depends, at least in part, on a percentage of a bet level.

9. The method of claim 1, wherein the maximum number of reel spins is at least four subsequent reel spins after the first reel spin.

10. The method of claim 1, wherein the reel comprises a first virtual reel displayed by a user interface of the computational device.

11. A computational device, comprising:
a user interface;
a processor coupled with the user interface; and
a computer-readable storage medium, coupled with the processor, comprising instructions that are executable by the processor, wherein the instructions comprise instructions that:
initiate a timer and a spin counter after a first reel spin of a reel;
determine if the timer is still active and if a maximum number of reel spins has been reached;
after one or more reel spins occurring subsequent to the first reel spin, if the timer is still active, and if the maximum number of spins has not been reached, then increment the timer and the spin counter;
when the maximum number of reel spins is reached, if the timer is still active, then determine a spin discount to apply to a next reel spin; and
apply the determined spin discount to the next reel spin.

12. The computational device of claim 11, wherein the spin discount to be applied to the next reel spin depends, at least in part, on at least one of: a current value of the timer and a bet level.

13. The computational device of claim 11, wherein the instructions further comprise:
instructions that detect a gesture of a player to a spin area and, in response to detecting the gesture of the player, cause the reel to spin.

14. A system, comprising:
a processor; and
a computer-readable storage medium, coupled with the processor, comprising instructions that are executable by the processor, wherein the instructions comprise instructions that:
initiate a first reel spin of a reel;
initiate a timer and a spin counter after the first reel spin of the reel;
initiate one or more reel spins subsequent to the first reel spin;
in response to the one or more subsequent reel spins, determine if the timer is still active and if a maximum number of reel spins has been reached;
if the timer is still active and if the maximum number of spins has not been reached, then increment the timer and the spin counter;
when the maximum number of reel spins is reached, if the timer is still active, then determine a spin discount to be applied to a next reel spin; and
apply the determined spin discount to the next reel spin.

15. The system of claim 14, wherein the timer comprises a countdown timer.

16. The system of claim 15, wherein incrementing the timer comprises resetting the timer or adding additional time to the timer.

17. The system of claim 14, wherein the spin discount depends, at least in part, on a current value of the timer and/or a bet level.

18. The system of claim 14, wherein the maximum number of reel spins is four subsequent reel spins after the first reel spin.

19. The system of claim 14, wherein the reel comprises a first virtual reel displayed by a user interface of a computational device.

20. The system of claim 14, wherein the reel comprises a mechanical reel.
